(19) United States
(12) Patent Application Publication
(10) Pub. No.: US 2005/0086244 A1
(43) Pub. Date: Apr. 21, 2005

(54) Matrixed organization apparatus

(76) Inventor: Paul Morinville, Georgetown, TX (US)

Correspondence Address: Law Offices of Mark L. Berrier, Bldg. 2, Ste. 300, 1250 Cap. of Texas Hwy. S., Austin, TX, 78746, US

(21) Appl. No.: 11/003,557

(22) Filed: Dec. 3, 2004

Related U.S. Application Data
(63) Continuation-in-part of application No. 10/417,929, filed on Apr. 17, 2003.
(63) Continuation-in-part of application No. 09/990,954, filed on Nov. 21, 2001.
Application No. 09/990,954 is a continuation-in-part of application No. 09/770,163, filed on Jan. 26, 2001, now abandoned.
(60) Provisional application No. 60/373,292, filed on Apr. 17, 2002.
(60) Provisional application No. 60/179,555, filed on Feb. 1, 2000.
(60) Provisional application No. 60/526,908, filed on Dec. 4, 2003.

(51) Int. Cl. G06F 7/00

(52) U.S. Cl. 707/100

(57) ABSTRACT

Systems and methods for dynamically and selectively generating a hierarchical functional organization from a hierarchical operating organization structure. In one embodiment, a hierarchical functional structure is generated by first identifying one of the positions in the operating organization structure from which the functional organization will be generated. After the starting position is identified, the positions in the hierarchical operational structure that are subordinate to the first one of the positions and that have roles which have at least one functional level in common with the role of the starting position are identified. Each of these positions can be classified according to its associated role. The level of classification may be selectable to include the associated functions, specialties and/or skills. A hierarchical structure based on the functional roles of the identified positions can be generated based on the classification.

### CROSS-REFERENCE TO RELATED APPLICATIONS

This application claims priority to: U.S. provisional patent application Ser. No. 60/526,908, by Paul Morinville, filed on Dec. 4, 2003; U.S. patent application Ser. No. 10/417,929, entitled “Business Process Nesting Method and Apparatus”, by Paul Morinville, filed on Apr. 17, 2003, which claims priority to U.S. Provisional Patent Application No. 60/373,292, by Paul Morinville, filed Apr. 17, 2002; and U.S. patent application Ser. No. 09/990,954, entitled “Signature Loop Authorizing Method and Apparatus”, by Paul Morinville, filed on Nov. 21, 2001, which is a continuation in part of U.S. patent application Ser. No. 09/770,163, by Paul Morinville, filed on Jan. 26, 2001, which claims priority to U.S. provisional patent application Ser. No. 60/179,555, by Paul Morinville, filed on Feb. 1, 2000; all of which are incorporated by reference as if set forth herein in their entirety.

### FIELD OF THE INVENTION

The invention relates generally to systems and methods for managing complex matrixed organizations. More specifically is relates to systems and methods for providing an operating organization, which is generally thought of as a Profit and Loss organization or a business unit organization, and many functional organizations, which are organizations of functions like Finance, Human Resources, Legal, Customers, Vendors, etc., embedded into different business units within the operating organization.

### BACKGROUND

Market conditions have driven companies to leverage employees, partners, suppliers, customers and information to reduce costs. To successfully accomplish this, organizations must efficiently control the way people, resources, and information technology interact. This can be referred to as Business Process Management (BPM). Within that control is the management of the identities of the users who interact with the systems by gaining access to resources or collaborating to accomplish a task. This can be referred to as Identity Management (IdM), Role Based Access Control (RBAC) and/or Role Based Collaboration and Approval.

Business processes are used to control costs, speed production, increase resource efficiency and control information that is shared among internal and external participants, and across applications. Thousands of business processes permeate such areas as engineering, manufacturing, distribution, sales, branding, marketing, advertising, purchasing, corporate communications, legal, customer relations, finance, staffing, payroll, benefits, training, employee records and more.

A business process is an ordered series of events, which manage changing of information from one or more sources to one or more destinations. Sources and destinations can be internal, customer, or partner applications, documents, vendor catalogs, etc. Business Rules may be applied to control how the change of information is accomplished. Business rules generally manage how a given business process is accessed, who collaborates to perform the change, and who approves it and in what order it is approved.

Access: Access is the ability of users to launch a particular business process or view certain information held in electronic systems. In most current systems, a user with access can see the engagement device of the business process, while a user without access cannot. In some systems, both can see it, but only the user with access can engage it. Companies must restrict access to certain users while allowing other users to have access to certain business processes and certain information. For example, the purchase of a computer is a business process. Business Rules may restrict access to certain users and thereby limit the type of employees who are authorized to purchase a particular computer. When the business process is launched, the price and description of the computer may be pulled from a vendor catalog, and the billing cost center, and user information may be pulled from internal company applications. Another example, certain user information such as social security number is required legally to be secured, however some users within an organization must have access to it for payroll and other purposes. Most companies grant access to HR or Finance people to user social security numbers and deny access to all others.

Collaboration: Often many users are required to collaborate to create, negotiate, change, etc. the subject matter of a business process. Business rules may also be applied to allow certain users to collaborate to change information held within the business process. For example, the IT Director may be allowed access to change the configuration of the computer while others would be disallowed. Or, a procurement negotiator, an in-house counsel and an external counsel may be required to each perform their part of a large purchasing contract.

Approval: Business Rules also may be utilized to control who approves the business process and in what order the business process is approved. For example, the user's first level manager, the area controller and the second level manager may all be required to approve the purchase of a computer. Business rules may require that the first level manager and the area controller both approve before the business process is routed to the second level manager. Once approved by all participants, the business process may be allowed to create the purchase order and complete the transaction.

A business process may require collaboration of individuals within the company or within an outside organization such as a vendor or partner. For example, the computer order may require a vendor representative to approve the sale if the original configuration has been altered during the business process.

Current Systems—Access: Current systems manage access to business processes by creating accounts and assigning access to business processes to the account. Users are in turn assigned to those accounts and receive access to business processes thru the account. For example, a Human Resources Management System may have accounts classified as employee, manager, HR manager, and administrator. Each account is assigned access to different business processes to secure information and control business processes. This method is effective in smaller companies where there are a limited number of employees and functions, but as the complexity of an organization grows, jobs specialize, and the number of users increases. This added complexity makes these systems less valuable because the specialization of jobs begins to specialize access requirements and it becomes very difficult to ensure that the right people are accessing the right information. For example, as a company gets larger, an additional account may be required for a recruiter, a training specialist and for a compensation analyst all requiring access to different items. In large companies where there are thousands of specializations, thousands of accounts are required. These systems cannot manage more than a couple of dozen accounts and prove to be ineffective.

Advanced systems have added the capability to create and manage hundreds or thousands of accounts to facilitate the complexity of job specialization. Many of these systems classify the accounts as Roles. These systems are often referred to a RBAC enabled systems, but they are only enabled for their own system. Their method of RBAC is not generally portable to other applications, so every system must be separately managed.

Most RBAC and some ldM systems are built around the capability of managing hundreds or thousands of role accounts, and are portable to many applications. They function as an overlying system to manage access rules to business processes that are running in other applications. These systems consolidate administration of business rules into one place.

Current Systems—Collaboration and Approval:

User Based: Current systems manage collaboration by passing an identifier of the individual user to the application managing the business process along with rules to determine when that person's collaboration or approval is required. The system may use that identifier to pick up whatever other information about the user from a directory service or other central repository of information like for example an e-mail address. The system may then send an email alert or some other sort of notification to the user using this information that their collaboration or approval is required. These systems are individual user centric. As users move in, within or out of the company, or the organizational structure changes thru a reorganization, divestiture, merger, etc., the system requires massive maintenance to keep the business processes aligned with the right people. For example, a business process to purchase a computer requires John Smith, the Controller, to approve the transaction. John Smith's ID is passed to the business process. The system pulls John Smith's email address from the directory service and sends John an email notification. If John is transferred to another business unit within the company, all the business processes that require John to approve or collaborate must be administered manually for all business processes in both the business unit the John is leaving and in the business unit that John is going to.

Role Based: Some advanced systems manage collaboration and approval rules using Roles by leverage a directory service. The directory is a repository for information regarding users, Role, reporting relationships, finance structure, departments, systems, applications, etc., which provides a single place to dynamically identity any or the above. Advanced systems query the directory using a variety of information to specifically identify a user required in collaboration or approval.

In the identification of people, current systems pass the department or business unit or other organizational identifier, with the role of the required user to the directory service. The directory service then returns the user's identifier and any other information required by the business process. For example, if a system requires the Controller for the Americas Sales group, it passes this information to the directory service and the directory service returns the identifying information for the Controller for the Americas Sales group. If the Americas Sales group breaks into four regions, or if it merges with the Asia Pacific Sales group, the directory service must be rebuilt so that all of the users are associated with the right business groups, which can be massive administration.

Organizational Structure: Generally, the organization of a company, government, non-profit or other entity consists of all the people, assets, services, costs and revenues associated with the company, government, non-profit or other entity. For the purposes of this document, company, government, non-profit or other entities are all referred to as a company. Companies organize their organizational structure differently for different purposes. Often, the same entities make up dozens of different hierarchical organizational structures each with its own specific purpose in managing the company, reporting information and rolling up government required reporting.

A person, for example, has a cost that must be represented in the profit and loss of the business unit in which they reside so they are rolled up in the hierarchical operating organization for these purposes.

The same person may be performing a functional role that impacts the business unit in which they reside, but also the company in general. Functional roles generally roll up in hierarchical functional organizations for people reporting purposes and other management purposes.

For example, a Controller who supports the Americas Sales group has costs associated with that the Americas Sales group and for P&L purposes that cost must rolled up in the Americas Sales profit and loss. The Controller is also responsible to that business unit for financial diligence and control and for those purposes reports to the VP of the Americas Sales group for management guidance. The controller is therefore part of the Americas Sales operating organization.

Conversely, the same Controller is responsible to drive functional financial initiatives that impact the company in general. Financial initiatives must be managed across business groups (operating organizations) and are managed in the finance functional organization. This organization is a hierarchical representation of all the financial roles in the company from all the business groups.

The requirements of an operating organization and a functional organization often conflict. For example, one functional Finance initiative may be to cut cost by restricting unnecessary purchases, while the Americas Sales group's initiative may be to mobilize the sales force by purchasing a laptop computer for every sales person. These initiatives conflict because one increases spending and the other reduces it. In this example, the controller is conflicted between the functional organizations initiative and the operating organizations initiative.

Most companies mange this conflict in a Matrixed or Dual Reporting organization. These organizations use the same entities but one is arranged operationally and the other is arranged functionally. For example, the Controller reports directly or hard line to the CFO thru the hierarchical functional organization, and also reports indirectly or dotted line to the VP of Americas Sales thru the hierarchical operating organization.

Organizational based Business Processes. Business processes are tools to help achieve initiatives. They are generally driven or managed within the organization where that initiative is primary. In other words, most companies will drive financial business processes thru financial systems controlled by the finance functional organization, HR business processes are driven thru the HR functional organization and sales business processes are sales operating organization.

Conflicts are managed thru organizationally based business processes. For example, the company may drive the functional business process to terminate an employee thru the functional organization and the operational business process of purchasing a lap top computer thru the operating organization. This restricts the ability to fire the controller to the CFO, which provides the necessary career stimulus to ensure that the Controller drives functional initiatives appropriately. The controller's career is essentially managed in the financial organization, while the controller works day to day supporting the VP Sales.

Operating Organization: An operating organization is the structure of business units in which profit and loss may be rolled up. Generally, all costs and revenues are rolled up through its structure for financial reporting purposes. Currently an operating organization is managed within the company's financial systems. For example, an operating organization may consist of a sales business, a product development business and a manufacturing business. The sales business may be further segmented into regions and/or product specialties. The product development business may be segmented into product specialties and within each product specialty it may be further segmented into engineering specialties. The costs and revenue associated with each segment at the lowest level is rolled up thru parent child relationships to create the profit and loss of the company overall. This structure is also necessary to provide management analysis and control of how money is being generated and spent at granular levels within the organization. An example of a hierarchical operating organization structure is illustrated in FIG. 1.

Functional Organizations: Functional Organizations are used to manage how people and assets report to each other within a function. A typical function consists of groups of similar skills that are required in most or all business units like Human Resources, Finance, Legal, Corporate Communications, etc, but they can also be skills required across a limited number of business units like Technical Support, Procurement, Supply Chain, Project Organizations, etc. Functional users reside within the operating business unit for P/L purposes, but report to directly their functional leader. This is sometimes referred to as “dual reporting”, “Matrixed Organization”, “Distributed Organization”, etc. in that the functional skill reports directly, or “hard line”, to the functional leader, and indirectly, or “dotted line”, to the business unit, or operating leadership. For example, a Finance Controller reports hard line to the CFO and dotted line to the VP of Sales.

Functional reporting relationships are important to drive and ensure the success of functional issues that impact the company overall. For example, Human Resources may need to impose a hiring freeze to minimize cost in a particular quarter, or Finance may need to control spending for the same purpose. Generally, only the hard line direct report has the ability to terminate or promote the user. For example, the VP Sales cannot fire the Controller, but the CFO can. This allows the function to “own the career” of functional employees and therefore positively influence them to drive functional initiatives even when the operating leadership is resistant. For example, if the CFO needs to stop all non-critical spending, they can ask their controllers not to authorize non-critical spending. In a well managed company, the operating leader cannot spend without the controller's authorization and the controller is not intimidated because they report thru the function not the operation. An example of a hierarchical functional organization structure is illustrated in FIG. 2.

Organizational Differentiation of Business Rules. Many business processes tend to be functional in nature in that they impact a function across multiple operating organizations, and business rules are managed differently from one business group to another within the operating organization to accomplish company goals. For example, HR business processes impact every employee in a company, but they impact the operating groups differently and therefore are managed differently. For example, one sales group may be adding headcount and therefore require minimal rules to hire new employees, while another sales group may be reducing headcount and require more stringent rules. Business rules are administered to the same functional hiring business processes in both cases, but have different access and approval requirements to drive their respective business initiative. In other words, business rules differentiate with respect to operating organizations at any level of that organization.

Conversely, a function like HR may wish to decrease overall HR headcount while increasing HR training headcount, so more stringent rules may be applied to hiring HR skills other than HR training skills. Business rules are administered to the same functional hiring process in both cases, but have different access and approval requirements within the function and not the operating groups. In other words, business rules differentiate with respect to functional organizations at any level of that organization.

Finally, HR may want to add those training heads to the sales group that is decreasing headcount. Business rules are administered to the same functional hiring business process, but these rules differentiate both with respect to the operating organization and with respect to the functional organization.

There are many examples of organizational rule differentiation. Rules governing product related business processes must differentiate with respect to various sales organizations. Rules governing technical support business processes must differentiate in respect to manufacturing and sales organizations. Rules governing sales business processes must differentiate across sales segments and geographies. Rules governing finance business processes must differentiate across all operating organizations and all functional organizations.

A function regulates business process rules first by the function's needs and then by the needs of the operating organizations. An operation regulates business process rules first by the operating organization's needs and then by the needs of the function's within it.

Current Systems

Organizational Management. Current systems manage each organization as its own separate entity and then manually relate organizations together as needed. In reorganization, the relationships between organizations change causing tremendous administration. Often, thousands of individual entries are required to perform financial applications, HR application, directory services, etc. to facilitate reorganization. There is no system currently available that manages complex organizations in a single system.

Organizational Differentiated Role-based Access Control. Each organization differentiates RBAC based on business circumstances affecting that organization, but most current systems do not associated RBAC rules directly with organizational structure. They are essentially flat in that each RBAC rules applies to all users having that role. Flat systems do not reflect current business management practices forcing companies to change the way they currently do business to accept the solution.

Some advanced systems table RBAC rules in a complex linking to organizational entities in a table or other database system. For example, access to a sales business process may be granted to sales people in all organizations, but differentiated by product, geography or customer in different operating groups. These systems pull tabled information by role, product, geography and/or operating group from the RBAC database to provide the correct access to the specific product, geography and/or operating group and thereby accomplish organizational differentiated access.

This provides the ability to differentiate RBAC rules organizationally, but when either the organization or RBAC rules change, massive administration is required to rebuild the table. For example, if the company splits a large sales group into different customer segments, the table must be completely rebuilt to accommodate the new organizational structure.

Some advanced systems allow for inheritance of business rules through an organizational structure. Generally, the organizational structure is constructed hierarchically in large blocks with each block containing all the entities required for that business unit. Inside each block the entities are arranged in a manner that is non-hierarchical, or flat. In other words, the block contains all the users within the block, but does not hierarchically arrange them within the block. The blocks are, however, arranged hierarchically and each block may inherit its business rules from its parent block.

For example, a company may have a sales block and within it are all the sales, HR and finance people. Subordinate to that sales block may be east and west coast sales groups with all the sales, HR and finance people within their respective organizations. Rules applied to the sales block are inherited by the subordinate east and west coast sales group blocks.

One or the other of the subordinate blocks could add rules to their block thereby facilitating organizational differentiation. All blocks subordinate in the hierarchy would inherit all the rules applied to any superior block to the top of the company. However, if the subordinate groups require further differentiation within themselves, it is not possible without reorganizing those groups into separate blocks either as a peer or a subordinate.

Further complicating these systems is that they utilize either the functional organization or the operating organization, but not both. While this provides the ability to differentiate RBAC rules either functionally or operationally, it does not provide the capability to differentiate rules functionally and operationally.

Role-based Collaboration. Role-based collaboration is essential to ensure compliance to government regulations by ensuring that separate authorities approve business processes thereby reducing the possibility of fraud.

Business processes impact the organization at the level closest to where it is initiated, so role-based collaboration systems must be able to identify the right user by role most closely related organizationally. For example, a financial controller is responsible to approve the financial impact of many business processes in their specific area of responsibility. A controller may be responsible for a function like HR, or an operating group like Sales. Different business processes launched in the same organization may need to identify either the HR controller for the HR organization, or the controller for the sales organization depending on the impact of the process. For example, a HR Generalist requires a new computer. The cost of the new computer is accounted for the operating organization so the business process must identify the controller for the sales organization for approval. Conversely, a business process to give a raise for the HR Generalist may require the controller for the HR organization approval.

Business processes impacting an operating group must identify the controller operationally, and business processes impacting a function must identify the controller functionally. Current systems cannot automatically make this determination without also including organizational information and other information.

The simplest systems pass a role to a directory service and the directory service returns a list of all users with that role. In large companies, the list could be dozens of people or hundreds of people. The initiating user must select which person is the right person and then the business process can move forward. Compliance, therefore, relies on user knowledge to select who is the right approver for each process making it nearly impossible to ensure compliance.

Advanced systems pass the role and other associated organizational information to select the user from the list automatically. Often, each organization is a named entity and the business process picks up the organizational identity where the business process initiates. For example, a business process launched in the North America Sales organization requires a Finance Controller. The system passes the controller role to the directory service and selects the user from the list who is assigned to the North America Sales group automatically. These systems work as long as the organization remains the same, but if North America Sales breaks into smaller geographies or segments, the system requires massive administration.

Clearly, a need for an automated system that manages a Matrixed Organization with the capabilities of also managing business rules both functionally and operationally with inheritance properties is needed.

### SUMMARY OF INVENTION

One or more of the problems outlined above may be solved by the various embodiments of the invention. Broadly speaking, the invention comprises systems and methods for automating and increasing the efficiency of a Matrixed Organization by managing a static or tabled operating organization and creating dynamic functional organizations based on the operating organization's structure.

One embodiment comprises a method for dynamically and selectively generating a hierarchical functional organization from a hierarchical operating organization structure. In this embodiment, a hierarchical functional structure is generated by first identifying one of the positions in the operating organization structure from which the functional organization will be generated. After the starting position is identified, the positions in the hierarchical operational structure that are subordinate to the first one of the positions and that have roles which have at least one functional level in common with the role of the starting position are identified. Each of these positions can be classified according to its associated role. The level of classification may be selectable to include the associated functions, specialties and/or skills. A hierarchical structure based on the functional roles of the identified positions can be generated based on the classification.

In one embodiment of the invention, there is a position based Operating Organization. Each position has only one parent position and may have one or more child positions.

In one embodiment of this invention, there is a hierarchical role. The hierarchical role is used to create dynamic functional organizations.

In the preferred embodiment of this invention, an apparatus is utilized to analyze the operating organization and dynamically create functional organizations using the operating organization and the hierarchical roles. This apparatus may be called at anytime the system requires the use or view of the functional organization for any purpose.

In one embodiment of this invention, both or either of operating organization or the functional organizational structures are leveraged to cascade access, collaboration and approval rules down thru the organization thru organizational inheritance properties.

### BRIEF DESCRIPTION OF THE DRAWINGS

FIG. 1 is diagram illustrating an exemplary hierarchical operating organization structure.

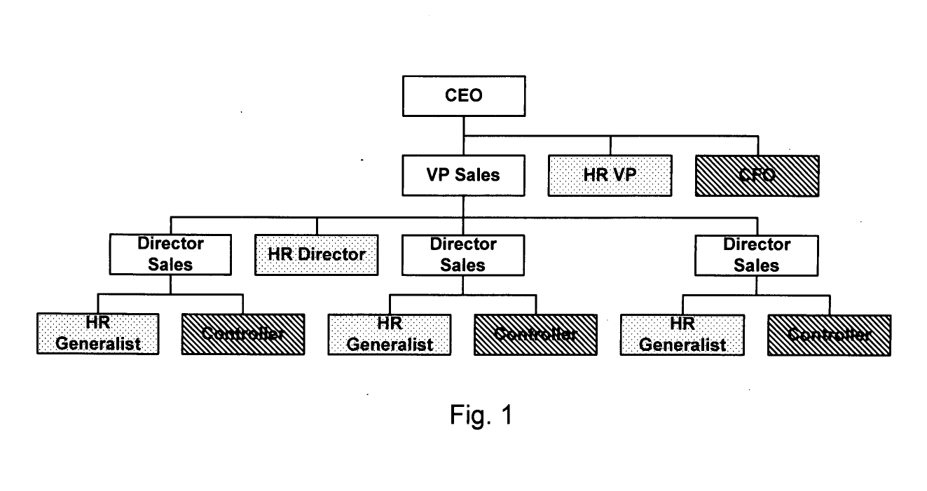

FIG. 2 is diagram illustrating an exemplary hierarchical functional organization structure.

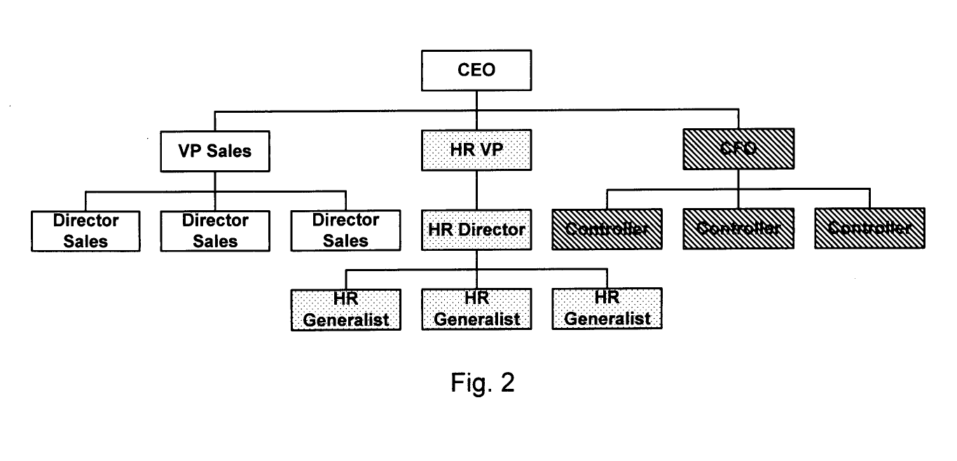

FIG. 3 is diagram illustrating a hierarchical operating organization structure in accordance with one embodiment.

FIG. 4 is diagram illustrating the hierarchical organization of roles within a company in accordance with one embodiment.

FIG. 5 is partial flow diagram illustrating the manner in which positions that will be included in a dynamic functional hierarchy are identified in accordance with one embodiment.

FIG. 6 is a continuation of the flow diagram of FIG. 5.

### DETAILED DESCRIPTION

Hierarchical Organizational Structure

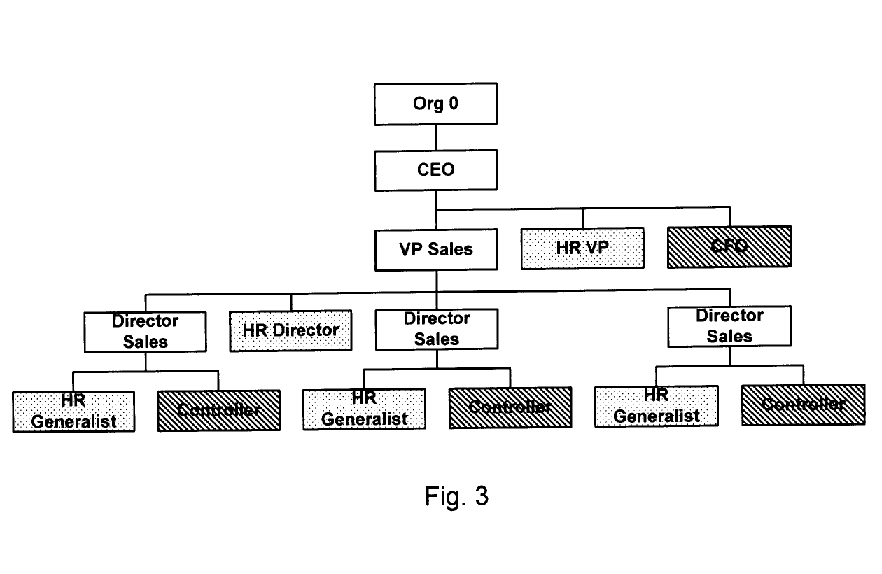

Referring to FIG. 3, the organizational structure is a hierarchical data structure of positions reporting to positions. Each position has an associated role which is used to control access to business processes and information, and is used by an apparatus to dynamically create functional organizations. (In some embodiments, there may be more than one role associated with each position.) The role is also used as the basis for identifying employees, contingent workers, vendors and partners for collaboration during business processes. Each position contains its own functional job description, functional title and mailing address. Each position can be identified from all other position by its place in the organizational structure. Each position is a tracking location for people, assets, services, roles and/or business processes.

In a preferred embodiment, the highest-level position in the organizational structure is “Org 0” (the organization). Org 0 is the only position in the organizational structure without a superior position. All positions ultimately report to Org 0. Org 0 serves as a repository for corporate information and as the location to track unassigned assets, services and other information.

In a preferred embodiment, the position of Org 0 in the organizational structure is defined in the system by the following rules: Org 0 cannot be created by the user, but is already programmed into the system when it is distributed to customers; Org 0 can only be the top position of the organizational structure; Org 0 cannot have a superior position; Org 0 may be the only position containing corporate information like billing address, banking information, etc.; Org 0 cannot have people tracked to it; Org 0 cannot be an approver; Org 0 must have one subordinate position (usually the CEO); and Org 0 cannot have more than one directly subordinate position.

In the preferred embodiment, positions other than Org 0 are defined by the following rules: they must have a superior position; they cannot have more than one superior position; they can have many direct subordinate positions; they must have a role; they may have more than one role; they can have an active user; they cannot have more than one active user; (a user is normally an employee or contractor, but can be a vendor, partner or consultant); when a position is transferred, its role and all tracked people, assets, services and business processes as well as all subordinate positions transfer with it; and a position cannot be terminated with active people, assets, services, business processes, or subordinate positions.

Roles: Hierarchical Role Structure

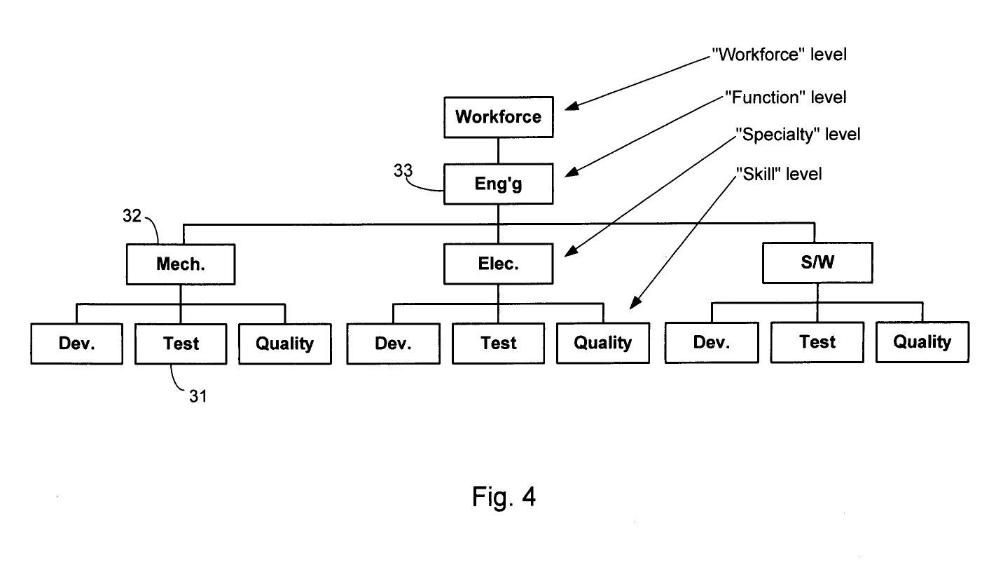

Referring to FIG. 4, the role structure comprises a hierarchical organization of roles within the company. Each role is a subset or specialization of the roles which are superior to it in the role structure. Each role can be associated with one or more of the positions in the organizational structure, and is used as the basis for controlling access of those employees associated with the corresponding organizational positions to particular business processes.

In a preferred embodiment, the hierarchical role structure comprises nine levels in three categories: functional role, superiority and legal. Each role in the organization can be related to the other roles in terms of these categories. For example, in FIG. 4, role 31 (Test) is a skill within the Mechanical specialty 32, which is in turn a subset of the Engineering function 33. It should be noted that the roles within each category may be independent of the roles in other categories. In other words, the levels associated with superiority roles or legal roles do not necessarily have a predetermined relationship to the levels associated with the functional roles. The functional, superiority and legal hierarchies may be coincident only at the organization (Org 0) level.

The role structure is used to provide the position, and thereby the user, with access to information and business processes; to identify positions in the organizational structure for collaboration on business processes (e.g., requesters and approvers); and to administer job related information through libraries containing information such as legal documentation, job descriptions, performance plan templates and compensation information.

As a result of the hierarchical function role structure, access rights to business processes are inherited from one level of the hierarchy to another. A particular function has the access rights assigned to that function, as well as access rights inherited from any level above it in the functional hierarchy. This enables the administration of large groups of employees at the same time, rather than forcing it to be done for individual employees. For example, if the hierarchy includes: workforce/HR/recruiters/exempt recruiters, executive recruiters, it is possible to freeze exempt hiring by taking away from the exempt recruiters access to an offer-letter business process. Then, no offers can be made to prospective employees. If this process is initially accessible to all recruiters, moving the access down a level to the executive recruiters results in a situation in which executives can be hired, but exempt employees cannot.

There are several rules relating to the role structure of the preferred embodiment: a role can be associated with many positions; a role is associated with a role is a specialization of the roles which are above it in the hierarchical role structure; a role cannot have more than one superior role; a role can have many direct subordinate roles; a role must be associated with at least one position; and a role can be associated with more than one position.

Functional Role. The first of the three categories to which roles may belong in the preferred embodiment is the category of functional roles. In this embodiment, there are four levels of functional roles. These roles comprise a hierarchical structure starting with “workforce”, which is the first level of all roles. Subsets of workforce include major functional skills or roles (such as Finance, Human Resources, Engineering, Sales, Marketing, etc.) These are further broken down into subsets of specialties. The specialty level is then broken down into subsets of skills.

Each level of the functional roles can be linked to page, purchasing or business process content. This allows the company to administer access across all employees, vendors, consultants and partners at the workforce level, to specific groups by function, to specialties within a function, and to skills within a specialty. This enables the company to easily and simultaneously manage access to sensitive information and business processes by participants across the entire company. Functional roles are linked to approval matrixes so that business process approvers can be identified, thereby enabling automated business process collaboration between participants, and enforcement of approval requirements.

Functional Organization: The functional organization is dynamically built by leveraging the Operating Organization by searching positions for Functional Roles based on their location within the Operating Organization and then constructing those position into the hierarchical functional organizations.

In one embodiment, a hierarchical functional structure is generated from the hierarchical operational structure of an organization by first identifying one of the positions from which the functional organization will be generated. If this position is the “Org 0” position, the resulting functional hierarchy will include all of the positions in the organization. If the position occupies a lower level in the organizational structure, only the positions subordinate to that position will be included in the dynamically generated functional hierarchy.

After the starting position is identified, the positions in the hierarchical operational structure that are subordinate to the first one of the positions and that have roles which have at least one functional level in common with the role of the starting position are identified. Each of these positions can be classified according to its associated role. The level of classification may be selectable to include the associated functions, specialties and/or skills. A hierarchical structure based on the functional roles of the identified positions can be generated based on the classification. The branches of the resulting structure include positions having common role characteristics (e.g., major function) or, if this information is not desired or specified, common operating organizations. The hierarchical levels of the operating organization structure are maintained in the functional hierarchy (e.g., a Human Resources Director would remain superior in the functional hierarchy to a Human Resources Generalist, even if they were not in the same operating organization.)

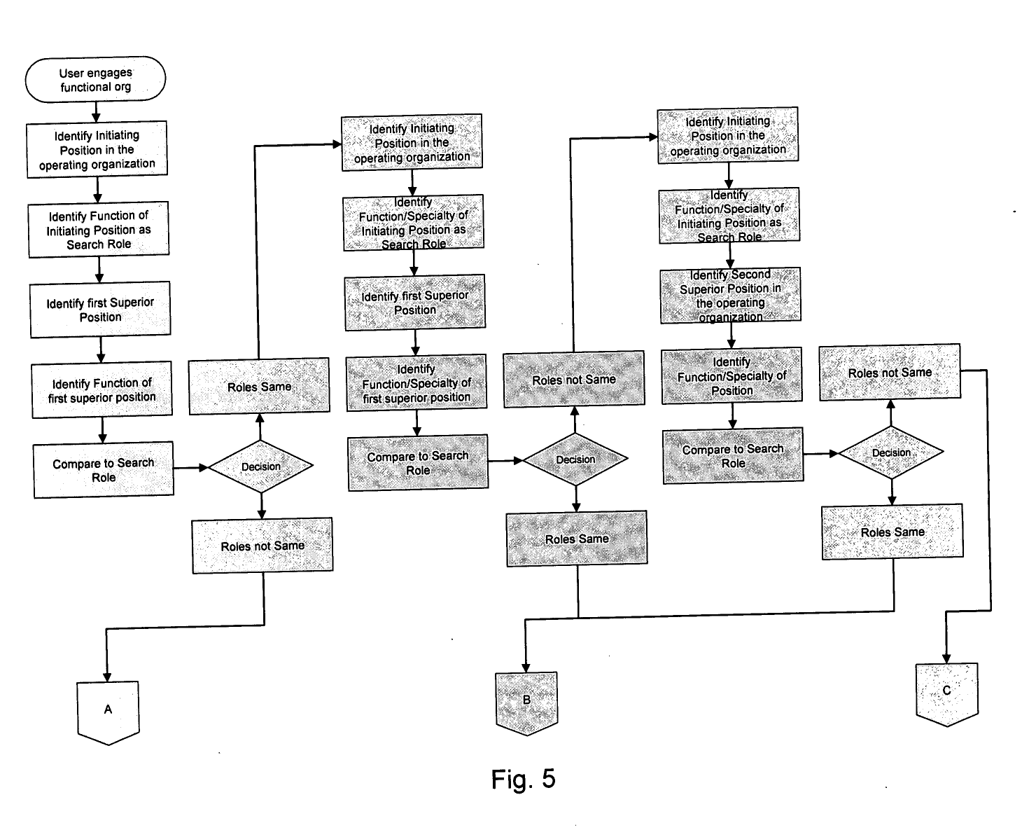

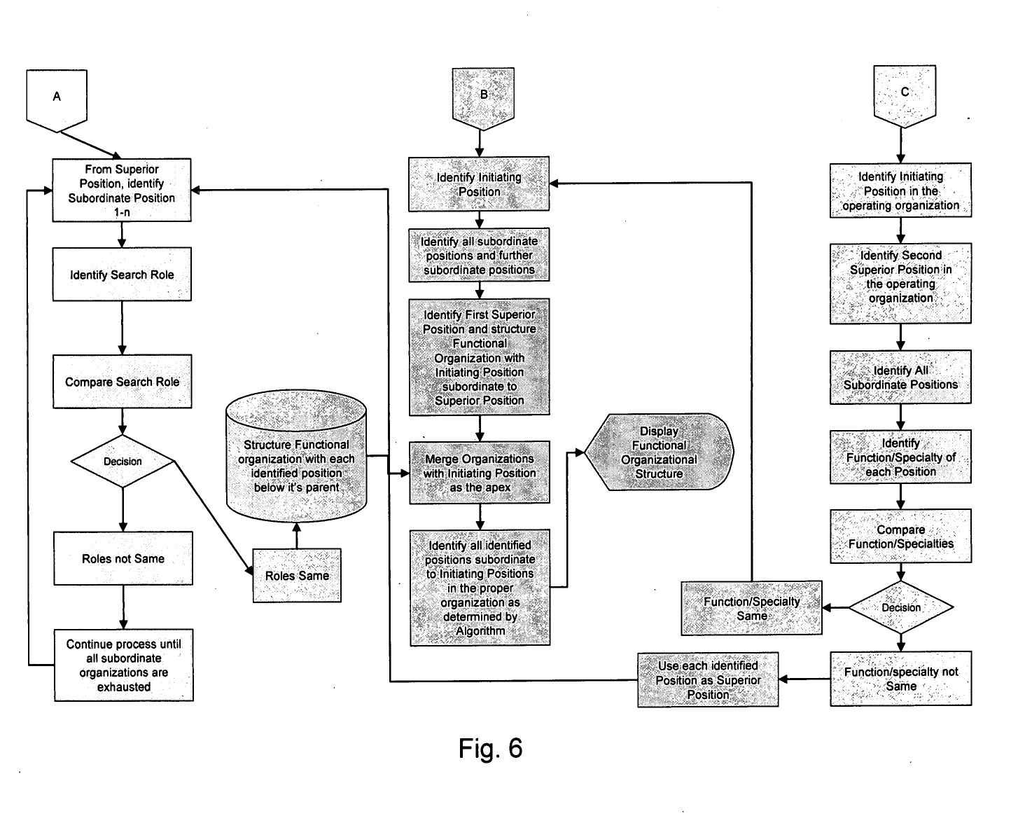

In one embodiment, the following search method may be used to identify the positions that will be included in the functional hierarchy. This method is illustrated graphically in the flow diagrams of FIGS. 5 and 6.

```
1. Virtual Functional Org
  1.1. Start search from position launching Functional Org (FUNCTIONAL POSTION
    1)
    1.1.1. Identify immediate SUPERIOR POSITION and examine Functional Role
      1.1.1.1. Identify Function of Functional Role and compare to function of the
          functional role of FUNCTIONAL POSITION 1
        1.1.1.1.1. If SUPERIOR POSITION function ≠ FUNCTIONAL
            POSITION 1 function
          1.1.1.1.1.1. Use Function only as SEARCH ROLE
            1.1.1.1.1.1.1. Go to 1.1.3
        1.1.1.1.2. If superior position function = FUNCTIONAL POSITION 1
            function
          1.1.1.1.2.1. Identify the Specialty of FUNCTIONAL POSITION 1
                  and compare to Specialty of SUPERIOR POSITION
            1.1.1.1.2.1.1. If SUPERIOR POSITION Specialty = FUNCTIONAL
                  POSITION 1 Specialty
              1.1.1.1.2.1.1.1. Error in organizational structure. Cannot build
                      org. Discontinue algorithm and go to 1.1.4.
            1.1.1.1.2.1.2. If SUPERIOR POSITION Specialty ≠ FUNCTIONAL
                  POSITION 1 Specialty
              1.1.1.1.2.1.2.1. Use Function and Specialty as SEARCH ROLE
                1.1.1.1.2.1.2.1.1. From SUPERIOR POSITION go up one
                        level to SECOND SUPERIOR POSITION and
                        go to 1.1.2
    1.1.2. From SECOND SUPERIOR POSITION, identify 1 to n immediate
        subordinate positions
      1.1.2.1. If subordinate position ROLE = SEARCH ROLE
        1.1.2.1.1. Error in organizational structure. Cannot build org.
            Discontinue algorithm and go to 1.1.4.
      1.1.2.2. If subordinate position ROLE ≠ SEARCH ROLE
        1.1.2.2.1. Use each subordinate position as SUPERIOR POSITION
          and go to 1.1.3
    1.1.3. From SUPERIOR POSITION, identify 1 to n immediate subordinate
        positions
      1.1.3.1. If subordinate position ROLE = SEARCH ROLE
        1.1.3.1.1. Error in organizational structure. Cannot build org.
            Discontinue algorithm and go to 1.1.3.
      1.1.3.2. If subordinate position ROLE ≠ SEARCH ROLE
        1.1.3.2.1. Identify 1 to n immediate subordinate positions
          1.1.3.2.1.1. If subordinate position ROLE = SEARCH ROLE
            1.1.3.2.1.1.1. Identify position as FUNCTIONAL POSITION 2-n
              1.1.3.2.1.1.1.1. Add FUNCTIONAL POSITION to functional
                        hierarchy as a subordinate position to FUNCTIONAL
                        POSITION 1-n
          1.1.3.2.1.2. If subordinate position ROLE ≠ SEARCH ROLE, go to
                1.1.3 and repeat algorithm with this position as SUPERIOR
                POSITION, but skip 1.1.3.1
      1.1.3.3. upon completion of entire organization go to 1.1.4
    1.1.4. From FUNCTIONAL POSITION 1, identify all subordinate positions and
        subordinate organizational structure and add it to the Functional
        Organization is its current hierarchical order below FUNCTIONAL
        POSITION 1.
```

The search may be utilized as required to dynamically leverage the virtual functional organization. In another embodiment, it may be utilized from time to time to create a “hard” functional organization that is written in data, and rewritten when changes to the organization occur.

Business rules may be set to drive from the functional organization or from the operating organization. In other words, the first level manager may be required for approval of a particular business process. If it is set to the operating organization and the Controller launches the business process, it would find the Director of Sales. If it is set to the functional organization and the Controller launches the business process, it will find the CFO.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with application specific integrated circuits (ASICs), field programmable gate arrays (FPGAs), general purpose processors, digital signal processors (DSPs) or other logic devices, discrete gates or transistor logic, discrete hardware components, or any combination thereof designed to perform the functions described herein. A general purpose processor may be any conventional processor, controller, microcontroller, state machine or the like. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in software (program instructions) executed by a processor, or in a combination of the two. Software may reside in RAM memory, flash memory, ROM memory, EPROM memory, EEPROM memory, registers, hard disk, a removable disk, a CD-ROM, or any other form of storage medium known in the art. Such a storage medium containing program instructions that embody one of the present methods is itself an alternative embodiment of the invention. One exemplary storage medium may be coupled to a processor, such that the processor can read information from, and write information to, the storage medium. In the alternative, the storage medium may be integral to the processor. The processor and the storage medium may reside, for example, in an ASIC. The ASIC may reside in a user terminal. The processor and the storage medium may alternatively reside as discrete components in a user terminal or other device.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein and recited within the following claims.

1. A method for dynamically generating a hierarchical functional structure from a hierarchical operational structure, comprising:
providing a hierarchical operational structure of unique positions within an organization;
associating one of a plurality of roles with each of the positions, wherein each of the roles has a corresponding major function, and wherein at least a subset of the roles is non-unique;
identifying a first one of the positions;
identifying positions in the hierarchical operational structure that are subordinate to the first one of the positions and that have roles which have at least one functional level in common with the role of the first one of the positions; and
generating a hierarchical functional structure of the identified positions.

2. The method of claim 1, wherein the identified positions in the hierarchical functional structure include less than all of the positions within the organization.

3. The method of claim 1, wherein a position initiating a business process for generation of a virtual functional organization is identified as the first one of the positions.

4. The method of claim 1, wherein the hierarchical functional structure of the identified positions includes separate branches corresponding to different skills within the roles.

5. The method of claim 4, wherein the hierarchical functional structure of the identified positions includes separate branches corresponding to different specialties within the roles.

6. The method of claim 5, wherein the hierarchical functional structure of the identified positions includes separate branches corresponding to different major functions within the roles.

7. The method of claim 1, wherein one or more of the positions corresponds to a business entity that includes a plurality of people.

8. The method of claim 1, wherein each of the positions corresponds to an individual person.

9. The method of claim 1, wherein the business process includes identifying positions in the hierarchical operational structure that are subordinate to the first one of the positions and that have roles which have the same major function as the role of the first one of the positions.

10. The method of claim 9, wherein the business process includes identifying positions in the hierarchical operational structure that are subordinate to the first one of the positions and that have roles which have the same major function and specialty as the role of the first one of the positions.

11. The method of claim 10, wherein the business process includes identifying positions in the hierarchical operational structure that are subordinate to the first one of the positions and that have roles which have the same major function, specialty and skill as the role of the first one of the positions.

12. A software program product comprising a storage medium containing one or more program instructions configured to cause a data processing device to perform a method including:
defining a hierarchical operational structure of unique positions for an organization;
associating one of a plurality of roles with each of the positions, wherein each of the roles has a corresponding major function, and wherein at least a subset of the roles is non-unique;
identifying a first one of the positions;
identifying positions in the hierarchical operational structure that are subordinate to the first one of the positions and that have roles which have at least one functional level in common with the role of the first one of the positions; and
generating a hierarchical functional structure of the identified positions.

13. A data processing device configured to:
define a hierarchical operational structure of unique positions for an organization;
associate one of a plurality of roles with each of the positions, wherein each of the roles has a corresponding major function, and wherein at least a subset of the roles is non-unique;
identify a first one of the positions;
identify positions in the hierarchical operational structure that are subordinate to the first one of the positions and that have roles which have at least one functional level in common with the role of the first one of the positions; and
generate a hierarchical functional structure of the identified positions.
